(19) United States
(12) Patent Application Publication
(10) Pub. No.: US 2025/0125720 A1
(43) Pub. Date: Apr. 17, 2025

(54) CIRCUIT FOR OUTPUT CURRENT REGULATION

(71) Applicant: Texas Instruments Incorporated, Dallas, TX (US)

(72) Inventor: Sergei Strik, SAN JOSE, CA (US)

(21) Appl. No.: 18/484,526

(22) Filed: Oct. 11, 2023

(51) Int. Cl. H02M 3/07; H02J 7/00; H02M 3/158

(52) U.S. Cl. CPC H02M 3/07; H02J 7/007182; H02M 3/158; H02J 2207/20

(57) ABSTRACT

Described embodiments include a charger circuit with a charge pump having a charge pump input and a charge pump output. The charge pump input is coupled to an input voltage terminal. A current sink is coupled between the charge pump output and a ground terminal, and has a current sink control terminal. A transistor is coupled between the input voltage terminal and an output voltage terminal, and has a control terminal. A driver circuit has a driver input, a driver output, a positive rail input, and a negative rail input. The driver output is coupled to the control terminal. The positive rail input is coupled to the charge pump output. The negative rail input is coupled to the output voltage terminal.

### BACKGROUND

This description relates to battery charger systems. Some battery charger systems are capable of operating in at least two operational modes. In a first operational mode, the battery charger system operates as a buck voltage converter, receiving power from an external source such as a wall outlet and providing DC current to charge a battery. In this operational mode, the battery charger system may include protection from reverse current and negative voltage transients for the devices in the power path.

In a second operational mode, some battery charger systems can operate as a boost charger, wherein the battery charger output terminal becomes an input terminal, and power from the battery can be used to charge an external device. Boost voltage converters usually include a current limit circuit to limit the output current of the voltage converter. In some instances, the current limit circuit obtains output current feedback information, then sets the duty cycle of the switching transistors to zero until the voltage converter goes into a dropout condition. When a voltage converter goes into a dropout condition, it can be difficult to limit its output current. This may lead to a relatively quick draining of the battery.

### SUMMARY

In a first example, a charger circuit includes a charge pump having a charge pump input and a charge pump output. The charge pump input is coupled to an input voltage terminal. A current sink is coupled between the charge pump output and a ground terminal, and has a current sink control terminal. A transistor is coupled between the input voltage terminal and an output voltage terminal, and has a control terminal.

A driver circuit has a driver input, a driver output, a positive rail input, and a negative rail input. The driver output is coupled to the control terminal. The positive rail input is coupled to the charge pump output. The negative rail input is coupled to the output voltage terminal.

In a second example, a battery charging system includes a first transistor coupled between an input voltage terminal and an output voltage terminal. The first transistor has a first control terminal. A high side drive transistor is coupled between the input voltage terminal and a switching terminal. The high side driver transistor has a high side control terminal. An inductor is coupled between the switching terminal and a battery terminal.

A charge pump has a charge pump input and a charge pump output. The charge pump input is coupled to the input voltage terminal. A current sink is coupled between the charge pump output and a ground terminal, and has a current sink control terminal. A driver circuit has a driver input, a driver output, a positive rail input, and a negative rail input. The driver output is coupled to the first control terminal. The positive rail input is coupled to the charge pump output. The negative rail input is coupled to the output voltage terminal.

### BRIEF DESCRIPTION OF THE DRAWINGS

FIG. 1 shows a block diagram for an example battery charging system.

FIG. 2 shows a schematic diagram for an example boost voltage converter.

FIG. 3 shows a schematic diagram for an example boost voltage converter with output current regulation.

### DETAILED DESCRIPTION

In this description, the same reference numbers depict same or similar (by function and/or structure) features. The drawings are not necessarily drawn to scale.

Some battery charger systems, such as many of the Li-ion battery charging systems found in products like mobile phones, have the capability to operate in either of two operational modes. In a first operational mode, a battery that is a component of the battery charging systems is charged by an external power source, such as an AC wall adapter. In a second operational mode, the battery operates as a power source providing power to a connected accessory or device, such as headphones. The connection between the power source and the battery charging system, or between the battery charging system and the connected accessory, may be through a bus. In at least one example, the bus is a universal serial bus (USB). The connection may also be a wireless connection.

In the first operational mode, a battery charger may receive an input from a power source for charging the battery. The power source may be a wall adapter coupled to the battery charger, or a wireless adapter coupled wirelessly to the battery charger. In the first operational mode, the battery charger operates as a buck voltage converter charging the battery by using, for example, a USB adapter to provide the power input. In the second operational mode, the charger can be used as a slave power charger by plugging in or wirelessly connecting to a headset or some other device such as a watch. The device is then charged using the battery as a power source. In this case, the charger operates as a boost voltage converter providing power from the battery to the device through the USB adapter or wirelessly.

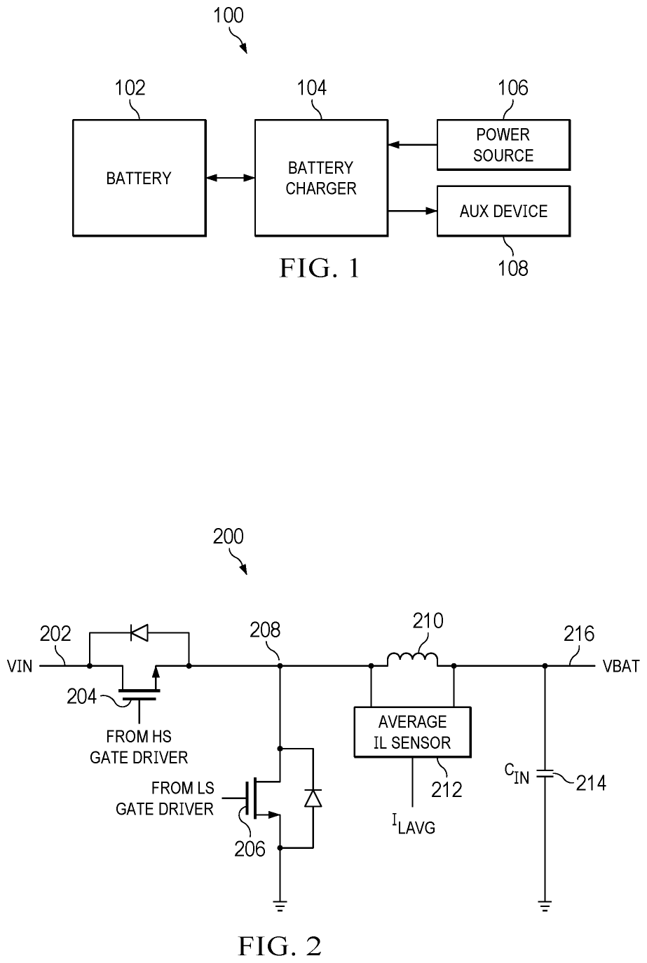

FIG. 1 shows a block diagram for an example battery charging system 100. Power source 106 can be an AC wall outlet connected to mains power, or alternatively could be a DC power source. In a first operational mode, power source 106 provides power to battery charger 104. In at least one example, battery charger 104 includes a USB adapter that is capable of converting an AC power signal to a DC power signal. The USB adapter is coupled to power source 106. Battery 102 is coupled to battery charger 104. In the first operational mode, battery charger 104 is providing power that is being sourced from power source 106 to battery 102.

In a second operational mode, battery charger 104 is coupled to an auxiliary device 108, which may be headphones or a watch, for example. In at least one example, battery charger 104 includes a USB adapter that is coupled to the auxiliary device 108. In at least one example, battery charger 104 is wirelessly coupled to the auxiliary device 108. In the second operational mode, battery 102 provides power to battery charger 104, which then provides power to the auxiliary device 108.

FIG. 2 shows a schematic diagram for an example boost voltage converter 200. A high side drive transistor 204 is coupled between an input voltage terminal VIN 202 and a switching terminal 208. Input voltage terminal VIN 202 may be coupled to a USB adapter. In at least one example, high side drive transistor 204 is an n-channel field effect transistor (NFET). The gate of high side drive transistor 204 is coupled to a high side gate driver (not shown), which controls turning high side drive transistor 204 on and off. A low side drive transistor 206 is coupled between the switching terminal 208 and a ground terminal. In at least one example, low side drive transistor 206 is an NFET. The gate of low side drive transistor 206 is coupled to a low side gate driver (not shown), which controls turning low side drive transistor 206 on and off.

An inductor 210 is coupled between switching terminal 208 and a battery terminal VBAT 216. A capacitor 214 is coupled between the battery terminal VBAT 216 and the ground terminal. Boost voltage converter 200 includes an average inductor current sensor 212 coupled between the switching terminal 208 and the battery terminal VBAT 216. Average inductor current sensor 212 senses the current through inductor 210 and provides information regarding the average inductor current at its output, IL_{AVG}.

A reverse current can flow from the battery at battery turn off, which could potentially damage circuitry at the input if it is left unprotected. In this case, the input is a USB adapter. Also, the adapter voltage can go negative, leading to an inrush current from the battery, which can cause the battery to drain quickly. High side drive transistor 204 does not provide adequate protection for the battery and the USB adapter against reverse current and the adapter voltage going negative.

When operating in boost regulator mode, an external device, such as a headset or a watch, can be plugged into the USB port. The external device can then be charged from power provided by the battery. In this case, the charger operates as a boost converter, regulating the output voltage and providing power to the external device. However, if the boost converter output voltage droops below the voltage level of the battery, high side drive transistor 204 may turn on and remain on with a 100% duty cycle. If this occurs, the battery may drain quickly if the current flowing from the battery at battery terminal VBAT 216 is not limited.

When a battery charger is configured as a boost converter, it is only able to limit its output current if its output voltage is greater than its input voltage due to body diode conduction of high side transistor 204. To protect the battery from an excessive current surge if the output voltage is less than the input voltage, an alternative current limit circuit may be added.

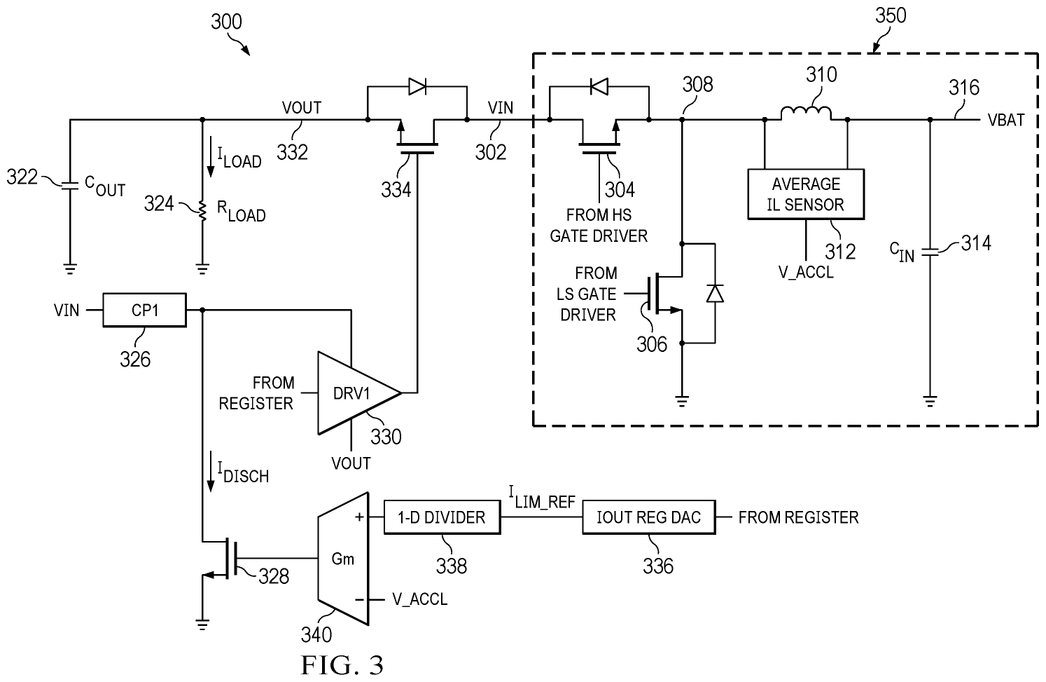

FIG. 3 shows a schematic diagram for an example boost voltage converter with output current regulation 300. Voltage converter 350 includes high side drive transistor 304, low side drive transistor 306, inductor 310, average inductor current sensor 312, and capacitor 314. High side drive transistor 304 is coupled between an input voltage terminal VIN 302 and a switching terminal 308. In at least one example, high side drive transistor 204 is an NFET. The gate of high side drive transistor 304 is coupled to a high side gate driver (not shown), which controls turning high side drive transistor 304 on and off.

Low side drive transistor 306 is coupled between the switching terminal 308 and a ground terminal. In at least one example, low side drive transistor 306 is an NFET. The gate of low side drive transistor 306 is coupled to a low side gate driver (not shown), which controls turning low side drive transistor 306 on and off.

An inductor 310 is coupled between switching terminal 308 and a battery terminal VBAT 316. A capacitor 314 is coupled between the battery terminal VBAT 316 and the ground terminal. An average inductor current sensor 312 is coupled between the switching terminal 308 and the battery terminal VBAT 316. The average inductor current sensor 312 senses the current through inductor 310 and provides at its output a voltage signal V_ACCL that is proportional to the average current through inductor 310.

Transistor 334 is coupled between the input voltage terminal VIN 302 and an output voltage terminal VOUT 332. In at least one case, transistor 334 is an NFET, but transistor 334 could be a bipolar junction transistor in other cases. A load resistance R_{LOAD} 324 is coupled between the output voltage terminal VOUT 332 and the ground terminal. An output capacitance COUT 322 is coupled between the output voltage terminal VOUT 332 and the ground terminal.

A driver 330 has an input coupled to a register output (not shown). The output of driver 330 is coupled to the control terminal of transistor 334. Charge pump CP1 326 has an input coupled to the input voltage terminal VIN 302. The output of charge pump CP1 326 is coupled to the positive supply terminal of driver 330. The negative supply terminal of driver 330 is coupled to the output voltage terminal VOUT 332. So, the voltage at the output of driver 330 is at the output voltage of charge pump CP1 326 when the input of driver 330 is a logic high, and the voltage at the output of driver 330 is at the voltage of the output voltage terminal VOUT 332 when the input of driver 330 is a logic low.

Transistor 328 is coupled between the output of charge pump CP1 326 and the ground terminal. Transistor 328 is an NFET in at least one case, but could be a bipolar junction transistor in other cases. An output current regulation digital-to-analog converter (DAC) 336 receives a digital input from a register (not shown) representing the desired output current limit. The output terminal of output current regulation DAC 336 is coupled to the input of a divider circuit 338.

The output of divider circuit 338 is coupled to a first input of transconductance amplifier 340. A second input of transconductance amplifier 340 is coupled to the output of average inductor current sensor 312 and receives the voltage V_ACCL. The output of transconductance amplifier 340 is coupled to the control terminal of transistor 328.

Transistor 334 provides protection to the USB adapter from reverse current and negative voltage transients when it is turned off. A reverse current can flow from the battery at battery turn off, which could potentially damage the input if left unprotected. In this case, the input is a USB adapter. Also, the adapter voltage may go negative, leading to an inrush current from the battery, which can cause the battery to drain quickly. In many traditional battery charger circuits, this protection is provided by two back-to-back FETs to protect the circuit from uncontrolled current flowing in either direction. However, circuit 300 is protected by a single transistor, transistor 334, that consumes a smaller area and is more power efficient than back-to-back FETs.

Transistor 334 can be reconfigured to act as a current limiter. So, instead of operating transistor 334 as a switch, transistor 334 can be operated in the linear region. The drain-to-source impedance of transistor 334 can be increased linearly. As the drain-to-source impedance of transistor 334 increases linearly, the current through transistor 334 decreases proportionally, allowing the current through transistor 334 to be limited.

In order to accurately regulate the output current, accurate output current feedback information is needed for the control loop. However, the accuracy of the current measurement decreases when transistor 334 begins operating in the saturation region, thus diminishing the effectiveness of the current limit control.

To accurately limit the output current, accurate output current information must be obtained. Accurate current information can be obtained by sensing the current flowing through inductor 310. Alternatively, in a system where back-to-back FETs are used, one of the FETs could be used as a current sensor, and the other FET could be used to regulate the output current. However, the use of two FETs increases the circuit area and decreases the circuit efficiency compared to the use of a single transistor. If transistor 334 is used to sense the output current, the current sensing information would not be valid when transistor 334 is operating in the linear region, which is how the current limit is being implemented. Therefore, information about the output current obtained from using transistor 334 as a current sensor would not be usable because it is inaccurate under certain conditions. So, average inductor current sensor 312 is used to provide accurate current information instead.

When in the boost voltage converter mode, the average current through the inductor is equal to the average current at the battery terminal VBAT 316. However, it is the current at the output voltage terminal VOUT 332 that is to be limited, not the current at the battery terminal VBAT 316. So, the relationship between the current at the battery terminal VBAT 316 and the current at the output voltage terminal VOUT 332 becomes important. The current at the output voltage terminal VOUT 332 is equal to the current at the battery terminal VBAT 316 divided by (1−D), where D is the duty cycle of the voltage converter:

I_{OUT}=I_{IN}/(1−D), where D is the duty cycle of the voltage converter.

The duty cycle of the voltage converter is equal to 1−VBAT/VIN.

Transistor 334 is controlled by the output of driver 330, which is supplied by charge pump CP1 326 on the positive rail, and the voltage at the output voltage terminal VOUT 332 on the negative rail. When the charge pump CP1 326 starts up, the output of driver 330 drives the control terminal of transistor 334 between the voltage at the output of charge pump CP1 326 and the voltage at the input voltage terminal VIN 302 plus 5 volts. So, the gate-to-source voltage (V_{GS}) of transistor 334 is either at 0V or 5V.

The V_{GS} of transistor 334 can be regulated by regulating the voltage provided at the output of driver 330. The voltage at the output of driver 330 can be regulated using the positive supply voltage of driver 330. The positive supply voltage of driver 330 can be controlled by overloading the charge pump CP1 326 beyond its current-sourcing capabilities. Requiring the output of charge pump CP1 326 to provide more current than it is capable of providing will cause the voltage at the output of charge pump CP1 326 to droop. If the positive supply voltage for driver 330 droops, V_{GS} of transistor 334 will also droop. When V_{GS} of transistor 334 decreases, the drain-to-source resistance of transistor 334 increases, reducing the current provided to the output voltage terminal VOUT 332.

Transconductance amplifier 340 receives the average inductor current information from average inductor current sensor 312 at a first input in the form of the voltage V_ACCL. Transconductance amplifier 340 compares the voltage V_ACCL to a scaled voltage representing a predetermined current limit. The predetermined current limit may be stored in a digital register and provided as an input to output current regulation DAC 336. To translate the input current information to an output current value, the voltage at the output of output current regulation DAC 336 can be divided by (1−D) and provided as a reference voltage at the second input to transconductance amplifier 340. Alternatively, the voltage V_ACCL can be multiplied by (1−D) and provided as the first input to transconductance amplifier 340. Either method will make the inputs to transconductance amplifier on the same scaled. The output of output current regulation DAC 336 is provided as the reference voltage at the second input to transconductance amplifier 340.

When the current at the output voltage terminal VOUT 332 increases, the voltage V_ACCL increases proportionally because the current at the input voltage terminal VIN 302 increases. When the voltage V_ACCL equals the reference voltage, the output of transconductance amplifier 340 turns on transistor 328 by increasing the V_{GS} of transistor 328. As the V_{GS} of transistor 328 increases, transistor 328 draws more current from the output of charge pump CP1 326. If the current-sourcing capability of charge pump CP1 326 is exceeded, charge pump CP1 326 is overloaded and the voltage at the output of charge pump CP1 326 will begin to droop. As the voltage at the output of charge pump CP1 326 begins to droop, the voltage at the output of driver 330 begins to droop, reducing the V_{GS} of transistor 334. Reducing the V_{GS} of transistor 334 increases the drain-to-source resistance of transistor 334, which reduces the current provided to the output voltage terminal VOUT 332. In this manner, the output current is regulated.

In at least one example, the output current regulation DAC 336 may be implemented as a bandgap and resistive DAC (RDAC). The digital input to the output current regulation DAC 336 may come from a user register that stores the selected current limit. For example, a voltage of 500 mV can be selected through the registers and provided as a digital input to the output current regulation DAC 336. The analog output of the output current regulation DAC 336 may then be provided as an input to divider circuit 338 where the voltage can be divided by a factor of (1−D).

If, for example, the 500 mV input to the output current regulation DAC 336 represents 1A of output current, and the output current reaches 1A, the two inputs to transconductance amplifier 340 come close in voltage to each other. This will turn on transistor 328, which will load the output of charge pump CP1 326, bringing down the voltage at the output of charge pump CP1 326. In at least one example, the register storing the current limit can be written to and changed dynamically, while in other examples, the current limit is a static value in the register.

In this description, “terminal,” “node.” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A charger circuit comprising:
a charge pump having a charge pump input and a charge pump output, wherein the charge pump input is coupled to an input voltage terminal;
a current sink coupled between the charge pump output and a ground terminal, and having a current sink control terminal;
a transistor coupled between the input voltage terminal and an output voltage terminal, and having a control terminal; and
a driver circuit having a driver input, a driver output, a positive rail input, and a negative rail input, wherein the driver output is coupled to the control terminal, the positive rail input is coupled to the charge pump output, and the negative rail input is coupled to the output voltage terminal.

2. The charger circuit of claim 1, further comprising an amplifier having first and second amplifier inputs and an amplifier output, wherein the first amplifier input is configured to receive an average load current signal, the second amplifier input is configured to receive a current limit signal, and the amplifier output is coupled to the current sink control terminal.

3. The charger circuit of claim 2, further comprising a voltage regulator circuit having a regulator input and a regulator output, wherein the regulator output is coupled to the input voltage terminal, and the regulator input is coupled to a battery voltage terminal.

4. The charger circuit of claim 2, further comprising a digital-to-analog converter (DAC) having a DAC input and a DAC output, wherein the DAC output is coupled to the second amplifier input.

5. The charger circuit of claim 4, further comprising a divider circuit having a divider input and a divider output, wherein the divider input is coupled to the DAC output, the divider output is coupled to the second amplifier input, and the divider circuit is configured to scale a signal at the DAC output to provide the current limit signal at the divider output.

6. The charger circuit of claim 3, wherein the voltage regulator circuit includes an inductor and an average current sensor having a current sensor output, in which the average current sensor is configured to provide the average load current signal at the current sensor output.

7. The charger circuit of claim 6, wherein the average load current signal represents an average of a current through the inductor.

8. The charger circuit of claim 4, further comprising a resistor and a capacitor coupled in parallel between the output voltage terminal and the ground terminal.

9. The charger circuit of claim 1, wherein the current sink includes a transistor.

10. The charger circuit of claim 2, wherein the amplifier is a transconductance amplifier.

11. The charger circuit of claim 1, wherein the driver circuit is configured to receive a digital logic signal at the driver input.

12. The charger circuit of claim 4, wherein the DAC is configured to receive, at the DAC input, a target current limit value from a digital register.

13. The charger circuit of claim 2, wherein the current sink is configured to draw enough current to cause a voltage at the charge pump output to droop in response to the average load current signal being greater than the current limit signal.

14. A battery charging system comprising:
a first transistor coupled between an input voltage terminal and an output voltage terminal, and having a first control terminal;
a high side drive transistor coupled between the input voltage terminal and a switching terminal, and having a high side control terminal;
an inductor coupled between the switching terminal and a battery terminal;
a charge pump having a charge pump input and a charge pump output, wherein the charge pump input is coupled to the input voltage terminal;
a current sink coupled between the charge pump output and a ground terminal, and having a current sink control terminal; and
a driver circuit having a driver input, a driver output, a positive rail input, and a negative rail input, wherein the driver output is coupled to the first control terminal, the positive rail input is coupled to the charge pump output, and the negative rail input is coupled to the output voltage terminal.

15. The battery charging system of claim 14, further comprising an average current sensor having a current sensor output, in which the average current sensor is configured to provide an average load current signal at the current sensor output.

16. The battery charging system of claim 15, wherein the average load current signal represents an average of a current through the inductor.

17. The battery charging system of claim 15, further comprising an amplifier having first and second amplifier inputs and an amplifier output, wherein the first amplifier input is coupled to the current sensor output, the second amplifier input is configured to receive a current limit signal, and the amplifier output is coupled to the current sink control terminal.

18. The battery charging system of claim 17, further comprising a digital-to-analog converter (DAC) having a DAC input and a DAC output, wherein the DAC output is coupled to the second amplifier input.

19. The battery charging system of claim 18, further comprising a divider circuit having a divider input and a divider output, wherein the divider input is coupled to the DAC output, the divider output is coupled to the second amplifier input, and the divider circuit is configured to scale a signal at the DAC output to provide the current limit signal at the divider output.

20. The battery charging system of claim 18, wherein the DAC is configured to receive, at the DAC input, a target current limit value from a digital register.

21. The battery charging system of claim 17, wherein the current sink is configured to draw enough current to cause a voltage at the charge pump output to droop in response to the average load current signal being greater than the current limit signal.
